(19) United States
(12) Patent Application Publication
(10) Pub. No.: US 2020/0148222 A1
(43) Pub. Date: May 14, 2020

(54) DRIVING SUPPORT DEVICE

(71) Applicant: AISIN SEIKI KABUSHIKI KAISHA, Kariya-shi, Aichi (JP)

(72) Inventors: Kinji YAMAMOTO, Anjo-shi, Aichi (JP); Tetsuya MARUOKA, Okazaki-shi, Aichi (JP); Kazuya WATANABE, Anjo-shi, Aichi (JP); Itsuko FUKUSHIMA, Anjo-shi, Aichi (JP); Takayuki NAKASHO, Anjo-shi, Aichi (JP)

(73) Assignee: AISIN SEIKI KABUSHIKI KAISHA, Kariya-shi, Aichi (JP)

(21) Appl. No.: 16/633,281

(22) PCT Filed: Feb. 19, 2018
(86) PCT No.: PCT/JP2018/005797

§ 371 Date: Jan. 23, 2020

(30) Foreign Application Priority Data
Sep. 25, 2017 (JP) 2017-183172

(51) Int. Cl. B60W 50/14; B60R 1/00; G02F 1/139; G02F 1/1347; G05D 1/02

(52) U.S. Cl. CPC B60W 50/14; B60R 1/00; B60W 2050/146; G02F 1/13471; G05D 1/027; G02F 1/139

(57) ABSTRACT

A driving support device includes a support unit configured to support driving by setting a target location for guiding a vehicle and a set route to the target location, a setting unit configured to set a transmissivity in accordance with a state of the vehicle with respect to the target location or the set route, and a generating unit configured to generate a display image including an indicator for supporting driving with the transmissivity.

### CROSS-REFERENCE TO RELATED APPLICATIONS

This application is a national stage application of International Application No. PCT/JP2018/005797, filed on Feb. 19, 2018, which designates the United States, incorporated herein by reference, and which claims the benefit of priority from Japanese Patent Application No. 2017-183172, filed on Sep. 25, 2017, the entire contents of which are incorporated herein by reference.

### TECHNICAL FIELD

Embodiments described herein relate to a driving support device.

### BACKGROUND

A device has been known that displays, on a display, a display image in which an indicator line for supporting travelling to a target location such as a parking frame 77 is superimposed on the parking frame 77 in a surrounding image of a vehicle.

### SUMMARY OF THE DISCLOSURE

However, there remains some leeway for improvement in that the above-mentioned device cannot make an occupant recognize how much travelling is required to a target location or on a set route.

In view of the above, according to an embodiment, there is provided a driving support device capable of displaying a state of a vehicle with respect to a target location or a set route.

A driving support device includes a support unit, a setting unit, and a generating unit. The support unit is configured to support driving by setting a target location for guiding a vehicle and a set route to the target location. The setting unit is configured to set a transmissivity in accordance with a state of the vehicle with respect to the target location or the set route. The generating unit is configured to generate a display image including an indicator for supporting driving with the transmissivity.

With this configuration, the driving support device according to an embodiment can help the occupant recognize a state of the vehicle with respect to the target location or the set route by making use of the transmissivity of the indicator.

In the driving support device according to an embodiment, the support unit sets the set route including a plurality of target locations. For each of the target locations, the setting unit increases the transmissivity as a distance from the vehicle to the target location decreases. The generating unit generates the display image including the indicator with the transmissivity, where, the indicator instructs movement to the target location.

With this configuration, the driving support device according to an embodiment can help the occupant to recognize the approach of the vehicle to each of the target locations, as the vehicle approaches the target location.

In the driving support device according to an embodiment, the support unit sets the set route including a plurality of target locations. For each of the target locations, the setting unit reduces the transmissivity as a distance from the vehicle to the target location decreases. The generating unit generates the display image including the indicator with the transmissivity, where the indicator instructs speed reduction.

With this configuration, the driving support device according to an embodiment can help the occupant more clearly recognize an instruction for speed reduction, as the vehicle approaches the target location, and also can help the occupant recognize that the vehicle is approaching the target location.

In the driving support device according to an embodiment, the setting unit increases the transmissivity as a steering angle of a steering unit of the vehicle approaches a target steering angle on the set route. The generating unit generates the display image including the indicator with the transmissivity, where the indicator instructs steering of the steering unit.

With this configuration, the driving support device according to an embodiment can help the occupant more clearly recognize that the steering of the steering unit needs to be terminated as the angle of the steering unit approaches the target steering angle, and also can help the occupant recognize that the steering angle of the steering unit is approaching the target steering angle.

In the driving support device according to an embodiment, the generating unit generates the display image including the indicator with the transmissivity that is constant, where the indicator instructs a steering direction of the steering unit.

With this configuration, the driving support device according to an embodiment can help a driver recognize a necessity for the termination of steering, and also can help the driver correctly recognize the direction of steering until the termination of steering by making the transmissivity of the direction indicator constant.

5

### BRIEF DESCRIPTION OF DRAWINGS

FIG. 1 is a plan view of a vehicle equipped with a driving support system of an embodiment;

FIG. 2 is a block diagram illustrating a configuration of the driving support system;

FIG. 3 is a functional block diagram illustrating functions of the driving support device;

FIG. 4 is a diagram of a transmissivity table example of a first embodiment;

FIG. 5 is a diagram of a display image example of the first embodiment;

FIG. 6 is a diagram of a display image example of the first embodiment;

FIG. 7 is a diagram of a display image example of the first embodiment;

FIG. 8 is a diagram of a display image example of the first embodiment;

FIG. 9 is a flowchart of driving support processing executed by a processing unit;

FIG. 10 is a diagram of a transmissivity table example of a second embodiment;

FIG. 11 is a diagram of a display image example of the second embodiment;

FIG. 12 is a diagram of a display image example of the second embodiment;

FIG. 13 is a diagram of a display image example of the second embodiment;

FIG. 14 is a diagram of a transmissivity table example of a third embodiment;

FIG. 15 is a diagram of a display image example of the third embodiment;

FIG. 16 is a diagram of a display image example of the third embodiment;

FIG. 17 is a diagram of a display image example of the third embodiment;

FIG. 18 is a diagram of a display image example of a fourth embodiment;

FIG. 19 is a diagram of a display image example of the fourth embodiment;

FIG. 20 is a diagram of a display image example of a fifth embodiment;

FIG. 21 is a diagram of a display image example of the fifth embodiment;

FIG. 22 is a diagram of a display image example of the fifth embodiment;

FIG. 23 is a diagram of a display image example of a sixth embodiment;

FIG. 24 is a diagram of a display image example of the sixth embodiment; and

FIG. 25 is a diagram of a display image example of the sixth embodiment.

### DESCRIPTION OF EMBODIMENTS

Embodiments exemplified hereinafter include similar components to one another, and the similar components bear common reference signs, and thus overlapping descriptions will be omitted as needed.

### First Embodiment

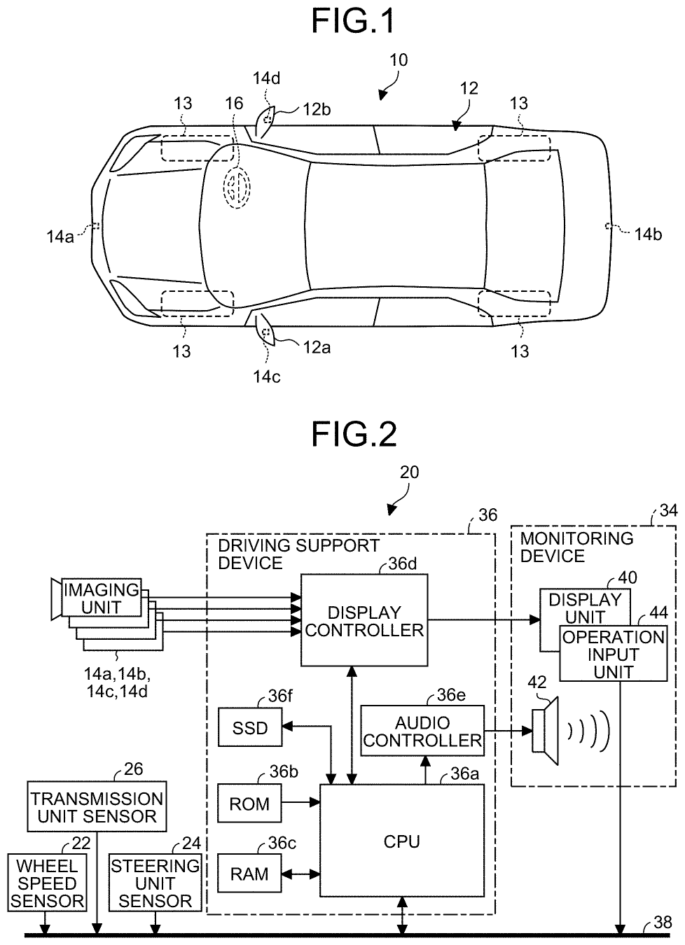

FIG. 1 is a plan view of a vehicle 10 equipped with a driving support system of an embodiment. The vehicle 10 may be a car (an internal combustion car) including both an internal combustion engine (an engine, not illustrated) as a driving source, may be a car (for example, an electric car or a fuel cell car) including an electric motor (a motor, not illustrated) as a driving source, or may be a car (a hybrid car) including an internal combustion engine and an electric motor as driving sources. Furthermore, the vehicle 10 may include various kinds of transmissions and various kinds of devices (for example, systems and parts) necessary for driving the internal combustion engine and the electric motor. For example, the system, the number, and the layout of device(s) related to the driving of a wheel 13 of the vehicle 10 may be determined as appropriate.

As illustrated in FIG. 1, the vehicle 10 includes a vehicle body 12, a plurality of (for example, four) imaging units 14a, 14b, 14c, and 14d, and a steering unit 16. In the case where the imaging units 14a, 14b, 14c, and 14d do not need to be distinguished from each other, the imaging units are referred to as imaging units 14.

The vehicle body 12 constitutes a vehicle interior in which an occupant gets on. The vehicle body 12 accommodates or holds components of the vehicle 10, such as the wheels 13, the imaging units 14, and the steering unit 16.

The imaging units 14 are each, for example, a digital camera with a built-in imaging element, such as a charge coupled device (CCD) or a CMOS image sensor (CIS). The imaging units 14 output, as captured image data, data on a moving image including a plurality of frame images generated at a predetermined frame rate or data on a still image. Each of the imaging units 14 includes a wide-angle lens or a fisheye lens, thereby being capable of capturing an image in a range from 140 degrees to 190 degrees in a horizontal direction. An optical axis of each of the imaging units 14 is specified to face obliquely downward. Thus, the imaging units 14 capture a plurality of images of the surroundings of the vehicle 10, including nearby road surfaces, and outputs data on the surrounding images.

The imaging units 14 are provided in an outer peripheral portion of the vehicle 10. For example, the imaging unit 14a is provided at a lateral center portion (for example, a front bumper) on the front side of the vehicle 10. The imaging unit 14a generates a surrounding image obtained by capturing an image of the surroundings ahead of the vehicle 10. The imaging unit 14b is provided at a lateral center portion (for example, a rear bumper) on the rear side of the vehicle 10. The imaging unit 14b generates a surrounding image obtained by capturing an image of the surroundings behind the vehicle 10. The imaging unit 14c is adjacent to the imaging unit 14a and the imaging unit 14b, and provided at a longitudinal center portion (for example, a left side view mirror 12a) on the left side of the vehicle 10. The imaging unit 14c generates a surrounding image obtained by capturing an image of the surroundings on the left of the vehicle 10. The imaging unit 14d is adjacent to the imaging unit 14a and the imaging unit 14b, and provided at a longitudinal center portion (for example, a right side view mirror 12b) on the right side of the vehicle 10. The imaging unit 14d generates a surrounding image obtained by capturing an image of the surroundings on the right of the vehicle 10. Here, the imaging units 14a, 14b, 14c, and 14d generate a plurality of overlapping surrounding images that is overlapped with each other and thereby containing a plurality of overlapped areas.

The steering unit 16 includes, for example, a handle or a steering wheel, and turns a turning wheel (for example, a front wheel) of the vehicle 10 by a driver's operation to change the lateral travel direction of the vehicle 10.

FIG. 2 is a block diagram illustrating a configuration of a driving support system 20 installed in the vehicle 10. As illustrated in FIG. 2, the driving support system 20 includes the imaging units 14, a wheel speed sensor 22, a steering unit sensor 24, a transmission unit sensor 26, a monitoring device 34, a driving support device 36, and an in-vehicle network 38.

The wheel speed sensor 22 includes, for example, a Hall element provided in the vicinity of the wheel 13 of the vehicle 10, and detects a wheel speed pulse wave including the number of pulses indicating the rotation amount of the wheel 13 or the number of revolutions thereof per unit time, as a value for calculating vehicle speed, for example. The wheel speed sensor 22 outputs, to the in-vehicle network 38, information on a wheel speed pulse (hereinafter, referred to as wheel speed pulse information) as one of vehicle information, that is, information about the vehicle 10.

The steering unit sensor 24 is an angle sensor including a Hall element, for example, and detects the rotation angle of the steering unit 16, such as a handle or steering wheel for operating the lateral travel direction of the vehicle 10. The steering unit sensor 24 outputs, to the in-vehicle network 38, information on the detected rotation angle of the steering unit 16 (hereinafter, referred to as rotation angle information) as one of the vehicle information.

The transmission unit sensor 26 is, for example, a location sensor detects a location of a transmission unit, such as a shift lever, for manipulating the transmission gear ratio and the fore-and-aft travel direction of the vehicle 10. The transmission unit sensor 26 outputs, to the in-vehicle network 38, information on the detected location of the transmission unit (hereinafter, referred to as positional information) as one of the vehicle information.

The monitoring device 34 is provided in, for example, a dashboard in a vehicle interior. The monitoring device 34 includes a display unit 40, an audio output unit 42, and an operation input unit 44.

The display unit 40 displays an image based on image data transmitted from the driving support device 36. The display unit 40 is, for example, a display device, such as a liquid crystal display (LCD) or an organic electroluminescent display (GELD). For example, the display unit 40 displays a display image including surrounding images obtained from the imaging units 14 by the driving support device 36.

The audio output unit 42 outputs a voice based on voice data transmitted from the driving support device 36. The audio output unit 42 is, for example, a speaker. The audio output unit 42 may be provided in the vehicle interior at a location differing from the location of the display unit 40.

The operation input unit 44 receives an input from an occupant. The operation input unit 44 is, for example, a touch panel. The operation input unit 44 is provided in a display of the display unit 40. The operation input unit 44 is capable of making an image displayed by the display unit 40 transparent. Thus, the operation input unit 44 can make the image displayed on the display of the display unit 40 seen by an occupant. The operation input unit 44 receives an input instruction by touching by an occupant on a location corresponding to the image displayed on the display of the display unit 40, and transmits the instruction to the driving support device 36.

The driving support device 36 is a computer including a microcomputer, such as an electronic control unit (ECU). The driving support device 36 generates a display image for supporting the driving of the vehicle 10, and displays the display image. The driving support device 36 includes a central processing unit (CPU) 36a, a read only memory (ROM) 36b, a random access memory (RAM) 36c, a display controller 36d, an audio controller 36e, and a solid state drive (SSD) 36f. The CPU 36a, the ROM 36b, and the RAM 36c may be integrated into the same package.

The CPU 36a is an example of a hardware processor, and reads out computer programs stored in a nonvolatile memory, such as the ROM 36b, and executes various kinds of operation processing and control in accordance with the computer programs.

The ROM 36b stores, for example, computer programs and parameters necessary for the execution of the computer programs. The RAM 36c temporarily stores various data to be used for calculation at the CPU 36a. The display controller 36d mainly performs, for example, image processing of images obtained at the imaging units 14 and the data conversion processing of a display image to be displayed at the display unit 40, among the calculation processing executed in the driving support device 36. The audio controller 36e mainly performs the processing of audio data to be output by the audio output unit 42 among the calculation processing in the driving support device 36. The SSD 36f is a rewritable nonvolatile memory which stores data even when the driving support device 36 is turned off.

The in-vehicle network 38 is, for example, a controller area network (CAN). The in-vehicle network 38 electrically connects between the wheel speed sensor 22, the steering unit sensor 24, the transmission unit sensor 26, the driving support device 36, and the operation input unit 44 so as to allow the mutual reception and transmission of signals and information.

In the present embodiment, the driving support device 36 executes driving support processing by collaboration between hardware and software (control program product). The driving support device 36 generates a display image in which an indicator for supporting driving is superimposed on a surrounding image including images of the surroundings captured by the imaging units 14, and displays the display image on the display unit 40 to support driving.

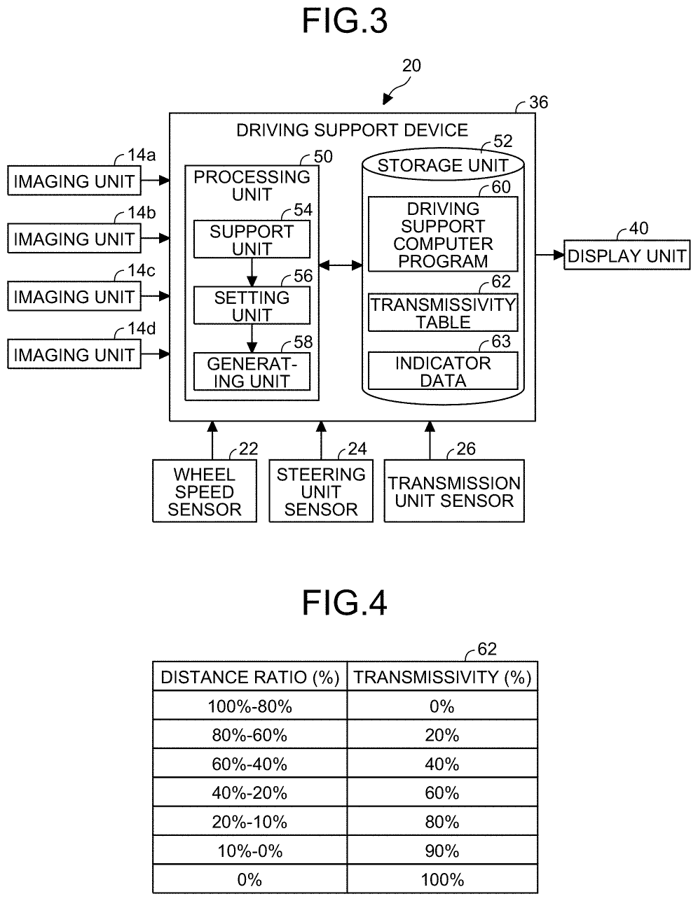

FIG. 3 is a functional block diagram illustrating a function of the driving support device 36. As illustrated in FIG. 3, the driving support device 36 includes a processing unit 50 and a storage unit 52.

The processing unit 50 is realized, for example, by functions of the CPU 36a and the display controller 36d. The processing unit 50 includes a support unit 54, a setting unit 56, and a generating unit 58. The processing unit 50 may read a driving support computer program 60 stored in the storage unit 52 to perform functions of the support unit 54, the setting unit 56, and the generating unit 58, for example. A part or all of the support unit 54, the setting unit 56, and the generating unit 58 may be configured with hardware such as a circuit including an application specific integrated circuit (ASIC).

The support unit 54 sets a target location for guiding the vehicle 10 and a set route to the target location, and thereby supports the driving of the vehicle 10. For example, the support unit 54 detects an obstacle surrounding the vehicle 10 and a target such as another vehicle based on the surrounding image obtained from the imaging unit 14. Note that the support unit 54 may detect a target based on both a surrounding image and information on distance to the target, the information having been obtained from a distance-measuring sensor. Based on the detected target surrounding the vehicle 10, the support unit 54 sets a final target location as a target location to finally guide the vehicle 10, such as a parking location. The support unit 54 sets a set route from a support starting location to the final target location. Here, the support unit 54 may have the set route include turnaround in the fore-and-aft direction. In this case, the support unit 54 sets a point for the turnaround in the fore-and-aft direction as a sub-target location on the set route. In the case where there is no need to distinguish the final target location from the sub-target location, the target location is simply referred to as a target location. In this case, the support unit 54 sets a set route including a plurality of target locations. The support unit 54 outputs information on the set target location and the set route to the setting unit 56 and the generating unit 58.

The setting unit 56 sets a transmissivity (including, for example, transparency) in accordance with a state of the vehicle 10 with respect to the target location and the set route. For example, the setting unit 56 acquires wheel speed pulse information from the wheel speed sensor 22, acquires rotation angle information from the steering unit sensor 24, and acquires positional information on the transmission unit from the transmission unit sensor 26. The setting unit 56 calculates the speed and the lateral travel direction of the vehicle 10 from the wheel speed pulse information and the rotation angle information, and determines a fore-and-aft travel direction from the positional information on the transmission unit. Based on the speed and the travel direction of the vehicle 10, the setting unit 56 calculates the distance on the set route from a present location of the vehicle 10 (hereinafter, referred to as the present vehicle location) to a next target location. The distance on the set route mentioned herein is an example of the state of the vehicle 10 with respect to a target location and a set route, and does not refer to a distance in a straight line from the present vehicle location to the target location, but refers to a distance to the target location along the set route.

The setting unit 56 sets a transmissivity based on the calculated distance to the target location. Specifically, the setting unit 56 increases the transmissivity as the distance from the vehicle 10 to the target location decreases. For example, based on a transmissivity table 62 stored in the storage unit 52, the setting unit 56 may set a transmissivity by using the ratio of the calculated distance to the target location. For example, when the distance from a support starting location or a target location to a next target location is taken as “100%”, the ratio of the distance to the target location may be the ratio of distance from a present vehicle location to the next target location with respect to the 100% distance. When the set route includes a plurality of target locations, for each of the target locations, the setting unit 56 may increase a transmissivity for the target location as the distance from the vehicle 10 to the target location decreases. The setting unit 56 outputs the set transmissivity to the generating unit 58.

The generating unit 58 generates a display image in which an indicator for supporting driving is superimposed on a surrounding image including images of the surroundings of the vehicle 10, the images having been acquired from the imaging units 14, and displays the display image on the display unit 40. For example, the generating unit 58 superimposes an indicator with a transmissivity set by the setting unit 56 on the surrounding image to generate a display image. Examples of the indicator include an arrow image that instructs movement in the fore-and-aft direction to a target location and indicates the target location in a surrounding image. The generating unit 58 acquires image data on an indicator from indicator data 63 of the storage unit 52.

The storage unit 52 is realized as at least one function of the ROM 36b, the RAM 36c, and the SSD 36f. The storage unit 52 may be an external memory provided in a network. The storage unit 52 stores, for example, a computer program to be executed by the processing unit 50, data necessary for the execution of the computer program, and data generated by the execution of the computer program. The storage unit 52 stores, for example, the driving support computer program 60 to be executed by the processing unit 50. The storage unit 52 stores the transmissivity table 62 necessary for the execution of the driving support computer program 60 and the indicator data 63 including image data on an indicator. The storage unit 52 temporarily stores, for example, a target location and a set route generated by the support unit 54 and a transmissivity set by the setting unit 56.

FIG. 4 is a diagram of an example of the transmissivity table 62 in the first embodiment. As illustrated in FIG. 4, the transmissivity table 62 is a table that creates an association between the ratio (%) of distance to a target location along a set route and the transmissivity (%) of an indicator. The setting unit 56 extracts a transmissivity associated with a calculated distance ratio from the transmissivity table 62, and sets the transmissivity. Thus, based on the transmissivity table 62, the setting unit 56 increases a transmissivity as the distance from the vehicle 10 to the target location decreases. Specifically, when the ratio of distance is 100% or lower and 80% or higher, the setting unit 56 sets the transmissivity at 0%. Similarly, when the ratio of distance is 80% or lower and 60% or higher, the setting unit 56 sets the transmissivity to 20%. As is the case of other ratios of distance, the setting unit 56 sets a transmissivity based on the transmissivity table 62. Note that, although the transmissivity table 62 in FIG. 4 includes seven stages of transmissivity in a range of from 0% to 100%, the number of stages of the transmissivity and the transmissivity at each stage may be suitably changed.

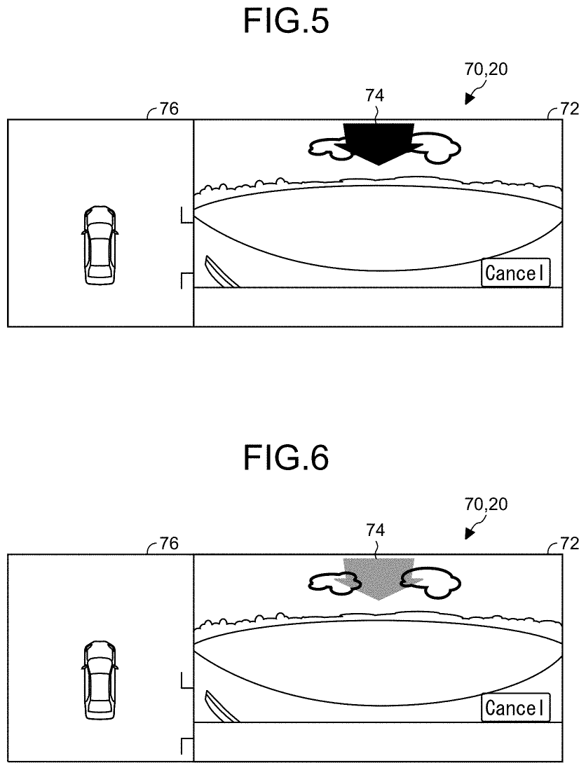

FIG. 5 to FIG. 8 are diagrams of examples of display images 70 in the first embodiment.

When the ratio of distance to a target location is 100%, the setting unit 56 sets, based on the transmissivity table 62, the transmissivity of an indicator 74 of image data included in the indicator data 63 to 0%. In this case, as illustrated in FIG. 5, the generating unit 58 generates a display image 70 in which the indicator 74 with a transmissivity of 0% is superimposed on a surrounding image 72 on the fore-and-aft travel direction side (for example, on the front side), and displays the display image 70 on the display unit 40. Note that, as illustrated in FIG. 5, the generating unit 58 may include a bird's-eye view image 76 in which the vehicle 10 and the surroundings of the vehicle 10 are viewed from above.

When a driver drives the vehicle 10 and the ratio of distance to the target location becomes smaller, the setting unit 56 gradually increases the transmissivity of the indicator 74 based on the transmissivity table 62.

For example, when the driver drives the vehicle 10 and the ratio of distance to a target location becomes 40%, the setting unit 56 sets the transmissivity of the indicator 74 to 60% based on the transmissivity table 62. At this time, as illustrated in FIG. 6, the generating unit 58 superimposes the indicator 74 with a transmissivity of 60% on a surrounding image 72 to generate a display image 70 in which a target overlapped with the indicator 74 is seen through, and displays the display image 70 on the display unit 40.

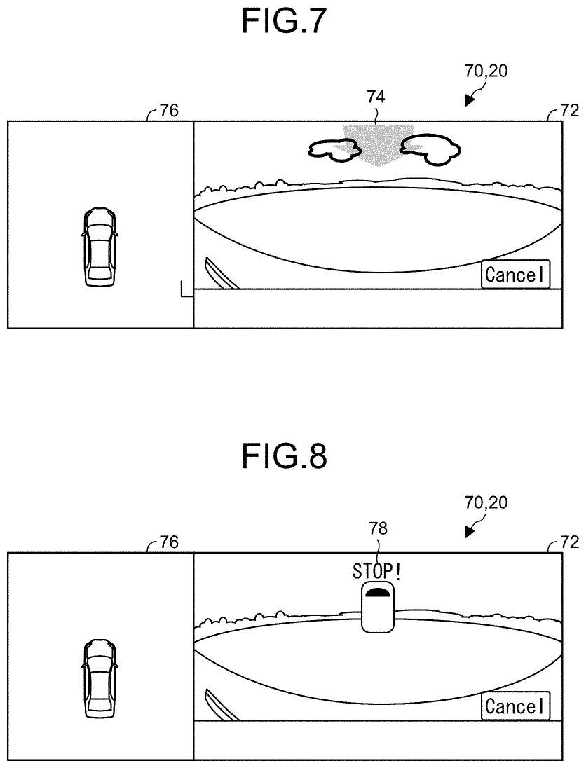

Furthermore, when the ratio of distance to the target location becomes 10%, the setting unit 56 sets the transmissivity of the indicator 74 to 90% based on the transmissivity table 62. At this time, s illustrated in FIG. 7, the generating unit 58 superimposes the indicator 74 with a transmissivity of 90% on a surrounding image 72 to generate a display image 70 in which a target overlapped with the indicator 74 is further seen through, and displays the display image 70 on the display unit 40.

When the driver further drives the vehicle 10 and the vehicle 10 arrives at the target location so that the ratio of distance to the target location becomes 0%, the setting unit 56 sets the transmissivity of the indicator 74 at 100% based on the transmissivity table 62. At this time, as illustrated in FIG. 8, the generating unit 58 deletes the indicator 74, and, at the same time, generates a display image 70 in which a stop icon 78 for instructing a driver to stop the vehicle 10 is superimposed on a surrounding image 72, and displays the display image 70 on the display unit 40.

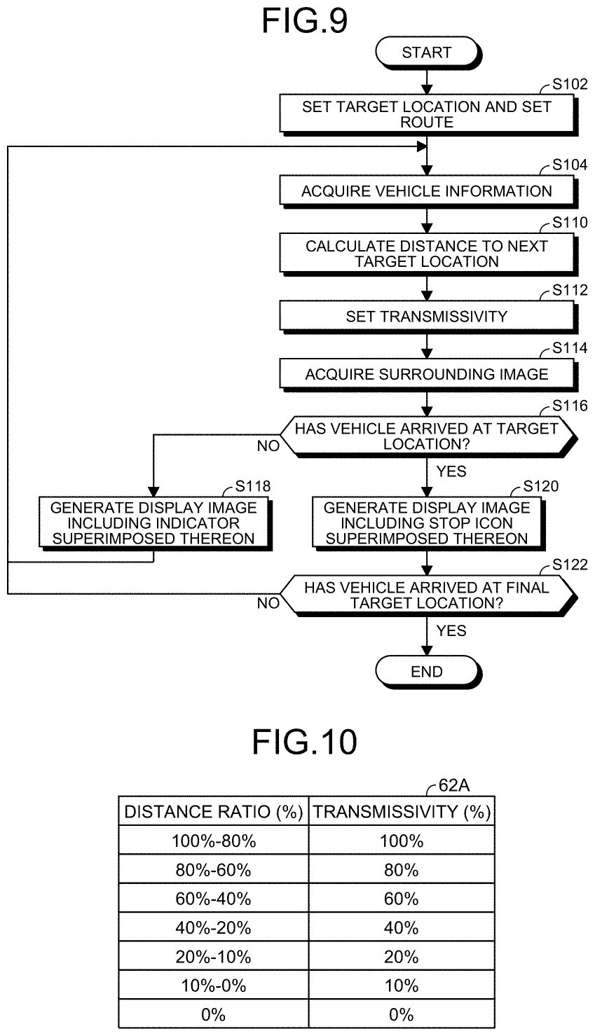

FIG. 9 is a flowchart of driving support processing executed by the processing unit 50. For example, when receiving an instruction for driving support from the operation input unit 44, the processing unit 50 reads a driving support computer program 60 stored in the storage unit 52 and executes driving support processing.

As illustrated in FIG. 9, in the driving support processing based on, for example, captured images acquired from the imaging units 14, the support unit 54 of the processing unit 50 sets a target location and a set route to a final target location, and outputs the target location and the set route to the setting unit 56 and the generating unit 58 (S102). The target location mentioned here includes, for example, a sub-target location such as a turnaround point, and a final target location such as a parking location.

Upon acquiring the target location and the set route, the setting unit 56 acquires wheel speed pulse information, rotation angle information of the steering unit 16, and vehicle information including positional information of the transmission unit, for example (S104). The setting unit 56 calculates a distance to a next target location on the set route based on the acquired wheel speed pulse information and the acquired rotation angle information. The setting unit 56 calculates the ratio of the distance from a present vehicle location of the vehicle 10 to a next target location with respect to the distance from a support starting location or a target location as a turnaround location to the next target location (S110). The setting unit 56 extracts a transmissivity associated with the calculated ratio of the distance to the target location from the transmissivity table 62, sets the transmissivity, and outputs the transmissivity to the generating unit 58 (S112).

When acquiring the transmissivity, the generating unit 58 acquires a surrounding image 72 from the imaging unit 14 (S114). The generating unit 58 determines whether the vehicle 10 has arrived at the target location (S116). For example, the generating unit 58 may determine whether the vehicle 10 has arrived at the target location based on the transmissivity acquired from the setting unit 56. Note that, if the transmission unit changes, for example, from drive to reverse, based on positional information of the transmission unit sensor 26, the generating unit 58 may determine that the vehicle 10 has arrived at the target location and the generating unit 58 may acquire a distance to the next target location from the setting unit 56 and determine whether the vehicle 10 has arrived at the target location based on the distance. If the transmissivity is not 100%, the generating unit 58 determines that the vehicle 10 has not arrived at the target location (No at S116). In this case, the generating unit 58 superimposes the indicator 74 with the acquired transmissivity on a surrounding image 72 to generate a display image 70 and displays the display image 70 on the display unit 40 (S118). Subsequently, the setting unit 56 and the generating unit 58 repeat Step S104 and subsequent steps, so that, as illustrated in FIG. 5 to FIG. 7, the generating unit 58 generates display images 70 in which the indicator 74, whose transmissivity having been gradually increased as the distance to the target location decreases, is superimposed on a surrounding image 72 and displays the display images 70 on the display unit 40 in sequence.

If the transmissivity is 100%, the generating unit 58 determines that the vehicle 10 has arrived at the target location (Yes at S116) and, as illustrated in FIG. 8, the generating unit 58 deletes the indicator 74, generates the display image 70 in which the stop icon 78 is superimposed on the surrounding image 72, and displays the display image 70 on the display unit 40 (S120). The generating unit 58 determines whether the vehicle 10 has arrived at a final target location (S122). By making use of, for example, a distance on the set route, the distance being calculated based on vehicle information, the generating unit 58 may determine whether the vehicle 10 has arrived at the final target location. If the generating unit 58 determines that the vehicle 10 has not arrived at the final target location (No at S122), the generating unit 58 repeats Step S104 and subsequent steps to support driving to the next target location. If the generating unit 58 determines that the vehicle 10 has arrived at the final target location (Yes at S122), the driving support processing is terminated.

As described above, the driving support device 36 of the first embodiment sets a transmissivity in accordance with a target location, a set route, and a state of the vehicle 10, and generates a display image 70 in which the indicator 74 with the transmissivity is superimposed on a surrounding image 72. Thus, the driving support device 36 can have a target, such as an obstacle, which is overlapped with the indicator 74, seen more clearly by an occupant, including a driver, and also can make the occupant recognize a state of the vehicle 10 with respect to the target location and the set route by making use of the transmissivity of the indicator 74.

The driving support device 36 of the first embodiment increases the transmissivity as the distance to a target location decreases and superimposes the indicator 74 with the transmissivity on a surrounding image 72. Thus, the driving support device 36 can make an occupant easily visually identify a target near the target location, the target overlapped with the indicator 74, and also can make the occupant recognize that the vehicle 10 is approaching the target location.

### Second Embodiment

A second embodiment will be described in which, for example, an indicator and a transmissivity differing from those in the first embodiment are set. FIG. 10 is a diagram of an example of a transmissivity table 62A of the second embodiment.

Based on the transmissivity table 62A illustrated in FIG. 10, the setting unit 56 of the second embodiment lowers a transmissivity for one target location or each of a plurality of the target locations, as the distance from the vehicle 10 to the target location decreases. For example, when the ratio of distance to a target location is 100%, the setting unit 56 sets the transmissivity at 100%. When the ratio of distance to the target location becomes 80%, the setting unit 56 sets the transmissivity to 80%. Thus, the setting unit 56 reduces the transmissivity as the ratio of distance to a target location decreases, and, when the ratio of distance becomes 0%, the setting unit 56 sets the transmissivity to 0%.

The generating unit 58 of the second embodiment superimposes an indicator for instructing speed reduction, having the transmissivity set by the setting unit 56, on a surrounding image 72 to generate a display image 70 and displays the display image 70 on the display unit 40.

FIG. 11 to FIG. 13 are diagrams of examples of display images 70 of the second embodiment.

When the ratio of distance to a target location is 100%, the setting unit 56 sets the transmissivity of an indicator 74a at 100% based on the transmissivity table 62A. In this case, the generating unit 58 generates a display image 70 including only a surrounding image 72, without superimposing the indicator 74a on the surrounding image 72, and displays the display image 70 on the display unit 40.

When the ratio of distance to the target location becomes 80%, the setting unit 56 sets the transmissivity of the indicator 74a to 80% based on the transmissivity table 62A. In this case, as illustrated in FIG. 11, the generating unit 58 generates a display image 70 in which the indicator 74a with a transmissivity of 80% is superimposed on the surrounding image 72 and displays the display image 70 on the display unit 40.

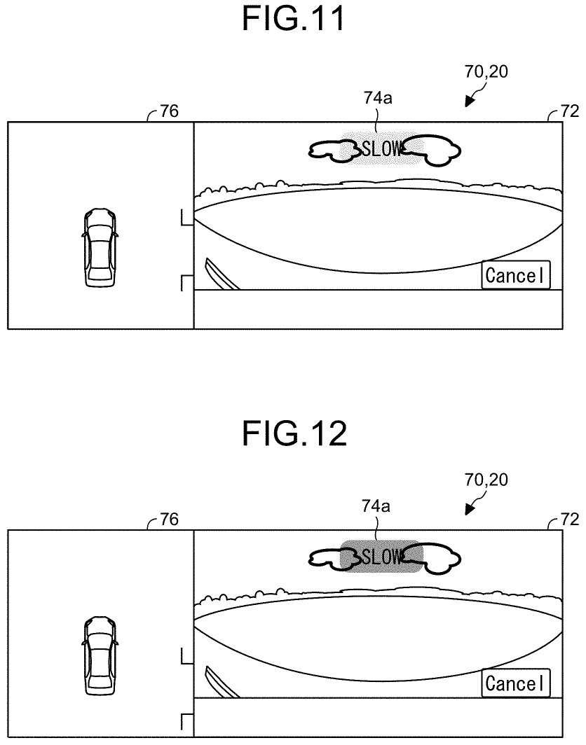

When the ratio of distance to the target location becomes 40%, the setting unit 56 sets a transmissivity of the indicator 74a to 40% based on the transmissivity table 62A. In this case, as illustrated in FIG. 12, the generating unit 58 generates a display image 70 in which the indicator 74a with a transmissivity of 40% is superimposed on the surrounding image 72 and displays the display image 70 on the display unit 40.

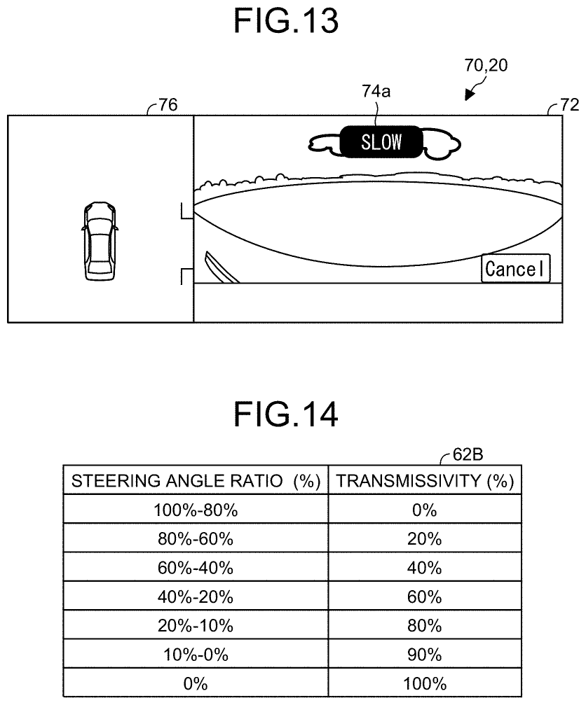

When the ratio of distance to the target location becomes 10%, the setting unit 56 sets the transmissivity of the indicator 74a to 10% based on the transmissivity table 62A. In this case, as illustrated in FIG. 13, the generating unit 58 generates a display image 70 in which the indicator 74a with a transmissivity of 10% is superimposed on the surrounding image 72 and displays the display image 70 on the display unit 40. In this case, when the transmissivity is not more than a threshold value defined beforehand for reversal, the generating unit 58 may reverse the color (for example, from black to white) of a character in the indicator 74a.

When the driver further drives the vehicle 10 and the vehicle 10 arrives at the target location so that the ratio of distance to the target location becomes 0%, the generating unit 58 may generate a display image 70 illustrated in FIG. 8, and display the display image 70 on the display unit 40.

The flow of driving support processing of the second embodiment is almost the same as the flow of the driving support processing of the first embodiment, and therefore, a description thereof will be omitted.

As described above, as the remaining distance to a target location decreases, the driving support device 36 of the second embodiment reduces the transmissivity of the indicator 74a for instructing speed reduction. Thus, as the vehicle 10 approaches the target location, the driving support device 36 can make an occupant more clearly recognize an instruction for speed reduction, and also can make the occupant recognize that the vehicle 10 is approaching the target location.

### Third Embodiment

A third embodiment will be described in which, for example, an indicator and a transmissivity differing from those in the above-described embodiments are set. FIG. 14 is a diagram of an example of a transmissivity table 62B of the third embodiment.

The setting unit 56 in the third embodiment sets a transmissivity in accordance with a state of the vehicle 10 with respect to a set route. Specifically, the setting unit 56 increases a transmissivity as the steering angle of the steering unit 16 of the vehicle 10 approaches a target steering angle. The target steering angle refers to a steering angle of the steering unit 16 for causing the vehicle 10 to travel along the set route. In the case where the support unit 54 sets a set route including a plurality of target locations, the setting unit 56 may increase a transmissivity for each of the target locations as the steering angle approaches the target steering angle.

For example, the setting unit 56 may set a transmissivity based on the transmissivity table 62B illustrated in FIG. 14. Specifically, when the ratio of the remaining steering angle to the target steering angle is 100%, the setting unit 56 sets the transmissivity to 0%. When the ratio of the remaining steering angle to the target steering angle becomes 80%, the setting unit 56 sets the transmissivity to 20%. Thus, the setting unit 56 increases the transmissivity as the steering angle approaches the target steering angle, and, when the ratio of the remaining steering angle becomes 0%, the setting unit 56 sets the transmissivity to 100%.

The generating unit 58 of the third embodiment superimposes an indicator for instructing the steering of the steering unit 16, having a transmissivity set by the setting unit 56, on a surrounding image 72 to generate a display image 70 and displays the display image 70 on the display unit 40. The indicator for instructing the steering of the steering unit 16 refers to an indicator indicating a necessity for steering without specifying a lateral direction. For example, the generating unit 58 displays an icon of the steering unit 16 as an indicator.

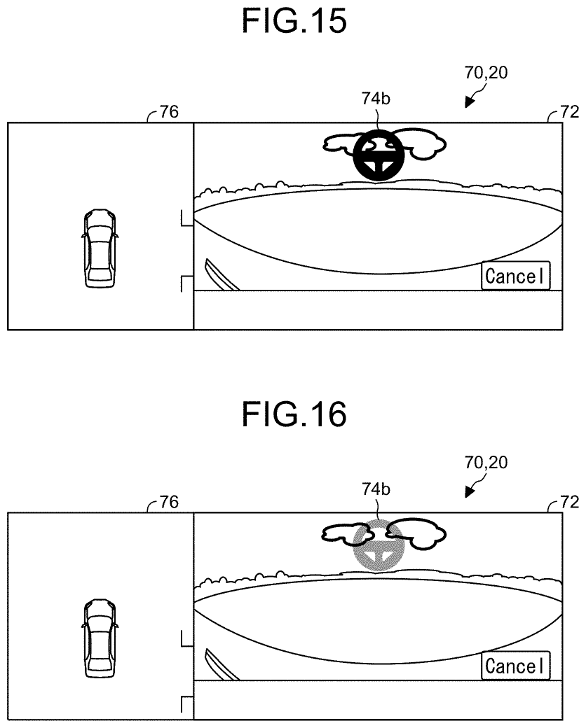

FIG. 15 to FIG. 17 are diagrams of examples of display images 70 of the third embodiment.

When the ratio of the remaining steering angle to a target steering angle is 100%, the setting unit 56 sets the transmissivity of an indicator 74b to 0% based on the transmissivity table 62B. In this case, as illustrated in FIG. 15, the generating unit 58 generates a display image 70 in which the indicator 74b is superimposed on a surrounding image 72, without transmissivity for the indicator 74b, and displays the display image 70 on the display unit 40.

When the ratio of the remaining steering angle to the target steering angle becomes 60%, the setting unit 56 sets the transmissivity of the indicator 74b to 40% based on the transmissivity table 62B. In this case, as illustrated in FIG. 16, the generating unit 58 generates a display image 70 in which the indicator 74b with a transmissivity of 40% is superimposed on the surrounding image 72 and displays the display image 70 on the display unit 40.

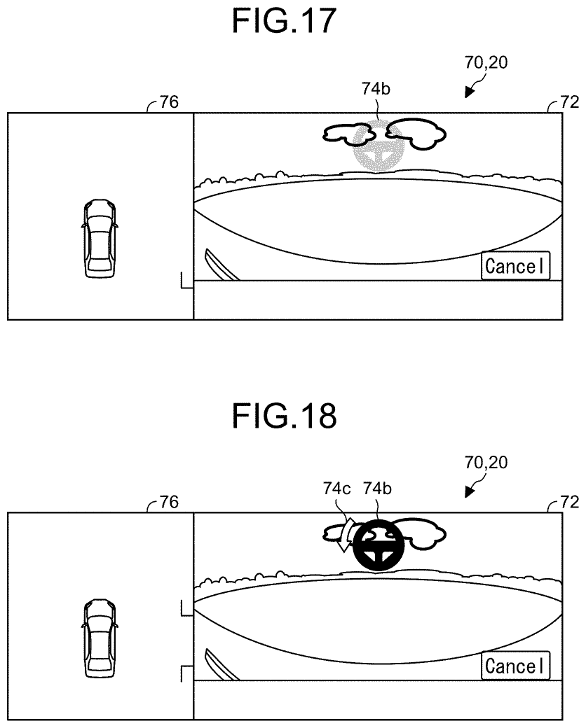

When the ratio of the remaining steering angle to the target steering angle becomes 10%, the setting unit 56 sets the transmissivity of the indicator 74b to 90% based on the transmissivity table 62B. In this case, as illustrated in FIG. 17, the generating unit 58 generates a display image 70 in which the indicator 74b with a transmissivity of 90% is superimposed on the surrounding image 72 and displays the display image 70 on the display unit 40.

When the driver further drives the vehicle 10 and the steering angle becomes the target steering angle so that the ratio of the remaining steering angle to the target steering angle becomes 0%, the generating unit 58 may generate a display image 70 illustrated in FIG. 8 and display the display image 70 on the display unit 40.

The flow of driving support processing of the third embodiment is almost the same as the flow of the driving support processing of the first embodiment, except that the remaining steering angle to a target steering angle is calculated and a transmissivity is set at Steps S110 and S112, and therefore, a description of the flow of the processing will be omitted.

As described above, as the steering angle approaches a target steering angle, the driving support device 36 of the third embodiment increases the transmissivity of the indicator 74b for instructing the steering of the steering unit 16. Thus, the driving support device 36 can make an occupant more clearly recognize that the steering of the steering unit 16 needs to be terminated as the steering angle approaches the target steering angle, and also can make the occupant recognize that the steering angle of the steering unit 16 is approaching the target steering angle.

### Fourth Embodiment

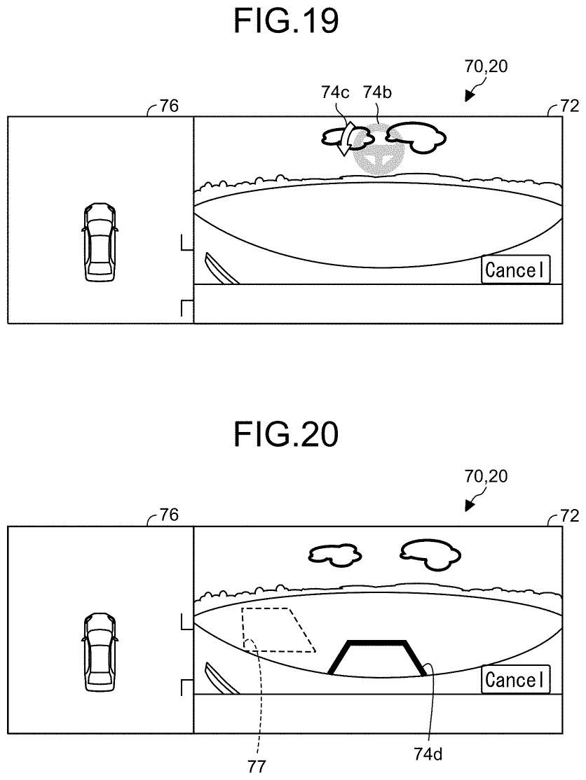

A fourth embodiment will be described in which an indicator and a transmissivity differing from those in the third embodiment are set. FIG. 18 and FIG. 19 are diagrams of examples of display images 70 of the fourth embodiment.

As illustrated in FIG. 18, the generating unit 58 of the fourth embodiment superimposes both the operation indicator 74b for instructing the operation of the steering unit 16 and a direction indicator 74c for instructing the steering direction of the steering unit 16 on a surrounding image 72 to generate a display image 70. Here, the generating unit 58 superimposes the operation indicator 74b with a transmissivity set by the setting unit 56 on the surrounding image 72, but, superimposes the direction indicator 74c with a constant transmissivity on the surrounding image 72 without changing the transmissivity of the direction indicator 74c. The transmissivity of the direction indicator 74c is set to 0%, for example.

Therefore, as illustrated in FIG. 19, even when the generating unit 58 superimposes the operation indicator 74b with an increased transmissivity on the surrounding image 72, the generating unit 58 superimposes the direction indicator 74c on the surrounding image 72 without changing the transmissivity of the direction indicator 74c, and thus generates a display image 70.

As described above, by increasing the transmissivity of the operation indicator 74b, the driving support device 36 of the fourth embodiment can make a driver recognize the termination of steering, and, by making the transmissivity of the direction indicator 74c constant, can make the driver correctly recognize the direction of steering until the termination of steering.

### Fifth Embodiment

A fifth embodiment will be described in which an indicator differing from those of the above-described embodiments is set. FIG. 20 to FIG. 22 are diagrams of examples of display images 70 of the fifth embodiment.

As illustrated in FIG. 20, the generating unit 58 of the fifth embodiment displays the indicator 74d indicating a travel direction of a vehicle 10, at a target location in a surrounding image 72 including the actual parking frame 77.

As the distance between the target location and the vehicle 10 decreases, the setting unit 56 increases the transmissivity based on the transmissivity table 62.

Therefore, when the ratio of distance to the target location becomes 40%, the setting unit 56 sets the transmissivity of the indicator 74d to 60% based on the transmissivity table 62. In this case, as illustrated in

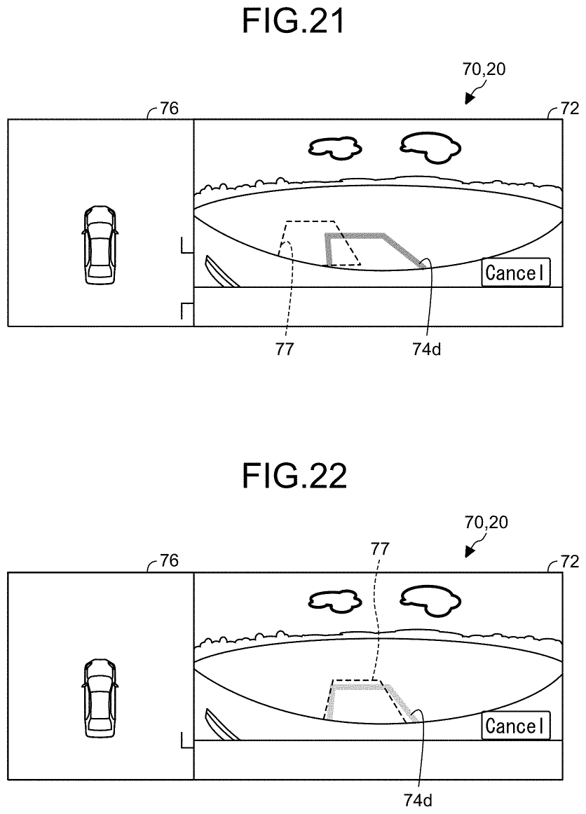

FIG. 21, the generating unit 58 superimposes the indicator 74d with a transmissivity of 60% on the surrounding image 72 to generate a display image 70 in which a part of the parking frame 77 overlapped with the indicator 74d is seen through, and displays the display image 70 on the display unit 40.

Furthermore, when the ratio of distance to the target location becomes 10%, the setting unit 56 sets the transmissivity of the indicator 74d to 90% based on the transmissivity table 62. In this case, as illustrated in FIG. 22, the generating unit 58 superimposes the indicator 74d with a transmissivity of 90% on the surrounding image 72 to generate a display image 70, in which a part of the parking frame 77 overlapped with the indicator 74d is further seen through, and displays the display image 70 on the display unit 40.

### Sixth Embodiment

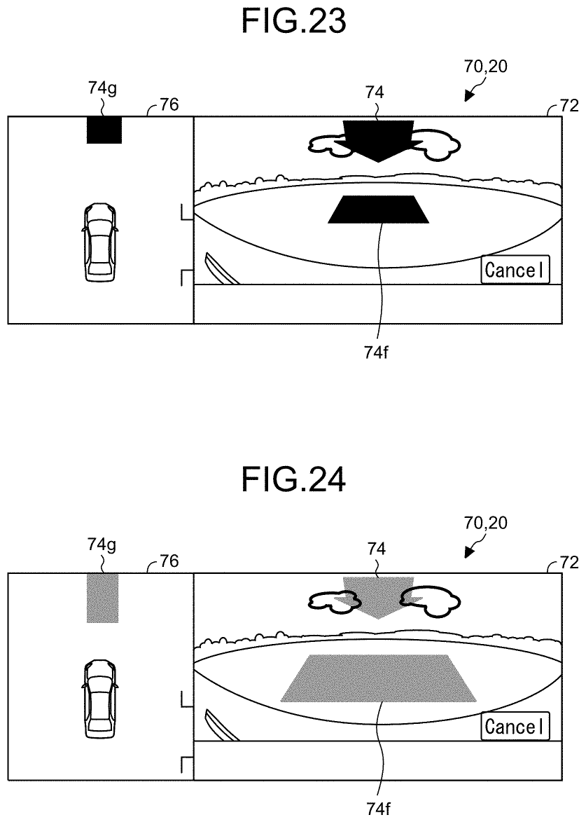

A sixth embodiment will be described in which an indicator differing from that of the first embodiment is set. FIG. 23 to FIG. 25 are diagrams of examples of display images 70 of the sixth embodiment.

As illustrated in FIG. 23, the generating unit 58 of the sixth embodiment superimposes both the indicator 74 for indicating a target location and a square framed indicator 74f corresponding in size to the vehicle 10 on the target location in a surrounding image 72. In this case, the generating unit 58 may display a square framed indicator 74g corresponding in size to the vehicle 10 on the target location in the bird's-eye view image 76.

As the distance between the target location and the vehicle 10 decreases, the setting unit 56 increases the transmissivity based on the transmissivity table 62.

Thus, when the ratio of distance to the target location becomes 40%, the setting unit 56 sets the transmissivity of the indicator 74 to 60% based on the transmissivity table 62. In this case, as illustrated in FIG. 24, the generating unit 58 superimposes the indicators 74, 74f, and 74g each having a transmissivity of 60% on a surrounding image 72 to generate a display image 70, in which a target overlapped with the indicator 74 is seen through, and displays the display image 70 on the display unit 40.

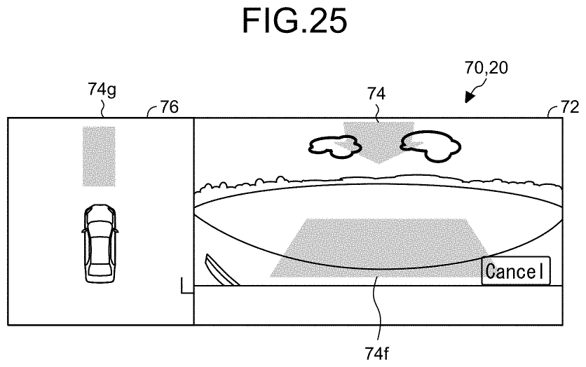

Furthermore, when the ratio of distance to the target location becomes 10%, the setting unit 56 sets the transmissivity of the indicator 74 to 90% based on the transmissivity table 62. In this case, as illustrated in FIG. 25, the generating unit 58 superimposes the indicators 74, 74f, and 74g each having a transmissivity of 90% on the surrounding image 72 to generate a display image 70, in which the target overlapped with the indicator 74 is further seen through, and displays the display image 70 on the display unit 40.

The functions, connections, number, arrangement, and others of the components in the above-described embodiments may be suitably changed or omitted within the scope of the invention and a scope equivalent to the scope of the invention. The embodiments may be suitably used in combination. The order of the steps in the embodiments may be suitably changed.

In the above-described embodiments, the driving support device 36 installed in the vehicle 10, such as a passenger car, was described as an example, but, the driving support device 36 may be installed in a vehicle such as a towing vehicle including a tractor.

In the above-described embodiments, an example in which the setting unit 56 sets a transmissivity based on the transmissivity table 62 was given, but, a method for setting a transmissivity is not limited to this. For example, the setting unit 56 may set a transmissivity based on a function defined beforehand and associated with a distance to a target location or a remaining angle to a target steering angle.

In the above-described third and fourth embodiments, examples in which the generating unit 58 displays the indicator 74b indicating the entirety of the steering unit 16 were given, but, the indicator indicating the steering unit 16 is not limited to them. For example, the generating unit 58 may display an image of the right or left half of the steering unit 16 as an indicator, and gradually change the transmissivity in accordance with a remaining angle to a target steering angle. In this case, the generating unit 58 preferably displays, as an indicator, an image of the half of the steering unit 16, the half being for instructing a driver to travel rightward or leftward. Specifically, in the case of instructing a driver to travel rightward, the generating unit 58 may display an image of the right half of the steering unit 16 as an indicator. In this case, the indicator of the steering unit 16 serves also as the arrow-shaped indicator 74c indicative of the direction of steering in the fourth. Furthermore, the generating unit 58 may display, on the opposite side to a travel direction, an image of the half of the steering unit 16 with a constant transmissivity (for example, 0%).

In the above-described embodiments, examples in which the setting unit 56 sets a transmissivity based on, for example, a distance to a target location on a set route and a steering angle for the set route were given, but a method for setting a transmissivity is not limited to them. The setting unit 56 beneficially sets a transmissivity in accordance with a state of the vehicle 10 with respect to a target location and a set route. For example, a transmissivity may be set, based on a distance in a straight line between a target location and the vehicle 10, as a state of the vehicle 10 with respect to the target location.

The above-described embodiments may be used in combination. In this case, on a surrounding image 72, the generating unit 58 may superimpose a plurality of the indicators 74, 74a and others selected from the indicator data 63 containing the indicators 74, 74a, and others. Alternatively, the generating unit 58 may change an indicator during driving support processing. For example, the generating unit 58 may superimpose the indicator 74 on a surrounding image 72 from the time of start of driving support processing until a vehicle arrives at a midpoint along the way to a next target location, and superimpose the indicator 74a on the surrounding image 72 from the midpoint until the vehicle arrives at the next target location. In this case, the setting unit 56 may set a transmissivity based on the transmissivity table 62 until the vehicle 10 arrives at a midpoint, and, from the midpoint onward, set a transmissivity based on the transmissivity table 62A.

The embodiments applied to driving support, such as parking assistance, were described as examples, but driving support to which the embodiments are applied, is not limited to parking assistance. For example, the embodiments may be applied to driving support, such as moving a vehicle sideways.

In the embodiments, an example was given in which an arrow and an image of the steering unit 16 are used as indicators, but an indicator is not limited to them. For example, the indicator may be, for example, an image of a course line or a present vehicle location.

In the embodiments, an example was given in which, when a present vehicle location becomes a target location or a steering angle becomes a target steering angle, the transmissivity is set to 100%, but the maximum of transmissivity is not limited to 100%. For example, even when a target location or a target steering angle is achieved, the transmissivity may be less than 100% (for example, 80%).

In the above-described embodiments, examples were given in which, at the time of the start of driving support or at the time when a vehicle passes by a target location, if the ratio of distance to the target location or the ratio of angle to a target steering angle is 100%, the transmissivity is set to 0%. However, the minimum of the transmissivity is not limited to 0%, and, for example, at the time of the start of driving support or at the time when a vehicle passes by a target location, the transmissivity may be higher than 0% (for example, 50%). For example, in the case where driving support needs to be started at a slow speed, the transmissivity at the time of start, for example, is made higher, and this can prevent a driver from increasing acceleration rapidly.

In the embodiments, examples were given in which the generating unit 58 superimposes the indicators 74, 74a and others on the surrounding image 72 to generate the display image 70, but the display image 70 generated by the generating unit 58 is not limited to this. For example, the generating unit 58 may generate a display image 70 not including a surrounding image 72, but including the indicators 74, 74a and others. The generating unit 58 may generate a display image 70 in which the indicators 74 and 74a are arranged outside a surrounding image 72.

1. A driving support device, comprising:
a support unit configured to support driving by setting a target location for guiding a vehicle and a set route to the target location;
a setting unit configured to set a transmissivity in accordance with a state of the vehicle with respect to the target location or the set route; and
a generating unit configured to generate a display image including an indicator for supporting driving with the transmissivity.

2. The driving support device according to claim 1, wherein
the support unit sets the set route including a plurality of target locations,
for each of the target locations, the setting unit increases the transmissivity as a distance from the vehicle to the target location decreases, and
the generating unit generates the display image including the indicator with the transmissivity, the indicator instructing movement to the target location.

3. The driving support device according to claim 1, wherein
the support unit sets the set route including a plurality of target locations,
for each of the target locations, the setting unit reduces the transmissivity as a distance from the vehicle to the target location decreases, and
the generating unit generates the display image including the indicator with the transmissivity, the indicator instructing speed reduction.

4. The driving support device according to claim 1, wherein,
the setting unit increases the transmissivity as a steering angle of a steering unit of the vehicle approaches a target steering angle on the set route, and
the generating unit generates the display image including the indicator with the transmissivity, the indicator instructing steering of the steering unit.

5. The driving support device according to claim 4, wherein the generating unit generates the display image including the indicator with the transmissivity being constant, the indicator instructing a steering direction of the steering unit.
